(19) United States
(12) Patent Application Publication
(10) Pub. No.: US 2002/0054648 A1
(43) Pub. Date: May 9, 2002

(54) Method for equalizing channel quality differences in a WDM system

(76) Inventors: Peter Krummrich, Muenchen (DE); Richard Neuhauser, Muenchen (DE); Albrecht Mayer, Muenchen (DE)

Correspondence Address: BELL, BOYD & LLOYD, LLC, P. O. BOX 1135, CHICAGO, IL, 60690-1135, US

(21) Appl. No.: 09/963,992

(22) Filed: Sep. 25, 2001

(30) Foreign Application Priority Data
Sep. 25, 2000 (DE) 100 47 342.3

(51) Int. Cl. H04B 7/10; H04L 1/02; H04L 27/20; H04L 27/12; H04L 27/04

(52) U.S. Cl. 375/295; 375/347

(57) ABSTRACT

A method for equalizing channel quality differences in a WDM system having N transmitters, N receivers and N channels wherein the following steps are performed: separately measuring in each case a bit error rate of each individual one of the N channels in each one of the N receivers, these being measured in each case at different decider thresholds, deviating from the optimum value, in N first decision circuits; determining the bit error rate at the optimum operating point by extrapolating the measured bit error rates for each individual one of the N channels; determining a Q value for each one of the N channels from the respective associated extrapolated bit error rates; calibrating the N transmitters via a control device by raising the levels of the channels having a high bit error rate and lowering the levels of the channels having a low bit error rate at the ratio of the respective Q value of the channel, the aggregate level of all N channels in the N transmitters being kept constant; and repeating the steps until all N Q values of the N channels in the N receivers are equal.

### BACKGROUND OF THE INVENTION

The present invention relates to a method for equalizing channel quality differences in a WDM system having N transmitters, N receivers and N channels.

The transmission capacity of optical transmission systems can be increased by multiplexing wavelengths while retaining the existing optical-fiber infrastructure. The dependence of some optical components and some effects on wavelength presents problems in the transmission in such WDM systems. This regularly leads to the channels used exhibiting different levels, optical signal/noise ratios (OSNR) and distortions at the end of the link. The maximum path length which can be bridged is predetermined by the channel which has the poorest signal quality or, respectively, highest bit error rate. If other channels have a much better bit error rate, this does not help in this connection but rather points to poor utilization of the system resources. It should, therefore, be the aim of the link design or of its optimization to achieve the same bit error rate for all channels at the end of the link. The bit error rate of a channel depends on a number of parameters. First, the level of the channel must be within the dynamic range of the receiver at the end of the link. Furthermore, the OSNR distribution at the end of the link has an influence on the bit error rate in the receivers. The OSNR distribution is determined by the channel level distributions at the inputs of the optical amplifiers in the individual link sections of the transmission path and their noise figure spectra and by multiple reflections or multi-path propagation, respectively. Signal distortion also has an influence on the bit error rate. The signal distortion is generated in the transmitters or receivers by the phase responses of optical components, for example the frequency response in filters and the dispersion of the transmission fibers, or by nonlinear distortion in the transmission fiber, for example four-wave mixing, cross-phase modulation or own-phase modulation.

This problem previously has been solved by setting the same signal levels for all channels at the beginning of the link in the transmitters with the aid of variable attenuation sections. Due to the wavelength-dependence of the components, the channel level differences increase almost continuously along the link. The great spread at the end of the link can be tolerated by having sufficient system reserves and by the dynamic range of the receivers. However, preemphasis of channel levels at the beginning of the link provides better utilization of the system resources. In this arrangement, the level distribution at the beginning of the link is selected in such a manner that the channels all exhibit the same OSNR at the end of the link. If the system operates with noise limiting and signal distortion does not play a role, an advantageous operating state is obtained at the end of the link. However, it has been found that signal distortion plays an ever increasing role. Having the same OSNR values at the receivers, therefore, does not guarantee correspondence of the bit error rate of all channels. Although signal distortion and OSNR can be balanced against one another to a certain extent so that a channel which has slightly more signal distortion at the end of the link than the other ones can be brought to the same bit error rate via a better OSNR, the OSNR can not be reliably determined in the case of WDM systems having very small channel spacings, so that it is not possible to carry out OSNR preemphasis.

It is, therefore, an object of the present invention to provide a method by which an equalization of channel quality differences can be achieved even with WDM systems having small channel spacings.

### SUMMARY OF THE INVENTION

Thus, a method according to the prresent invention operates by determining Q values which are used for weighting the signal quality and raising or lowering individual channel levels at the beginning of the link with a constant aggregate level for equalizing the quality differences. A Q value is determined by measuring a bit error rate of each individual channel in the individual receivers at different decider thresholds and phase angles which deviate from the optimum value. The bit error rates measured are extrapolated at the optimum operating point for each individual one of the channels and, thus, the bit error rate is determined. From this bit error rate, a Q value is then determined for each one of the channels. This Q value is a measure of the signal quality. Compared with determining the bit error rate, i.e. directly counting errors within a certain period of time, however, this prevents a determination of the bit error rates from leading to immensely large measuring periods at low error rates, which is not practicable. In contrast, the Q values can be measured within a relatively short time. However, the Q value takes into consideration not only the OSNR of the channel but also signal distortion and, thus, allows a much better estimate of the bit error rate to be obtained. When the Q value is measured by displacing the decider threshold and phase angle of the receiver, distortion is detected not only in the transmitter and along the link but also in the receiver. For a channel for which a small Q value has been determined, the level is raised via a control device in the transmitter. Raising the level at the beginning of the link usually increases the OSNR value of the channel at the end of the link, and thus also the Q value. For a channel for which a large Q value has been determined, in contrast, the level is lowered in the transmitter. Raising or lowering in the transmitters is done at the ratio of the individual Q values determined, the aggregate level of the channels being kept constant. This is repeated until the same Q values are obtained for all channels in the receivers. The desired ideal state is then reached that all channels have the same quality. The path length which can be bridged is then at a maximum.

It is advantageous if beforehand there is preemphasis in which the level distribution in the N transmitters is changed in such a manner that the OSNR values of the N channels are matched in the N receivers by measuring the level distribution in the N receivers and controlling the level distribution in the N transmitters via the control device. Although measuring the Q values leads to a much better result than the known method of determining the OSNR values of the channels at the end of the link, it is advantageous to put such a determination before the method according to the present invention. The operation state of the WDM system thus found is used as initial state for a further calibration to equal Q values. Since the level distribution for equal Q values and OSNR values is not too far apart with signal distortion which is still tolerable in practice, this two-stage procedure allows a much faster level adjustment of the WDM system.

It is also advantageous if the N Q values of the N channels are in each case measured in a second decision circuit, associated with the respective receiver, during the operation of the WDM system. On the one hand, this takes into consideration distortion which occurs before the decision circuit in the receiver and, on the other hand, such a method allows the preemphasis, during which the WDM system is in operation, to be continuously recalibrated.

Additional features and advantages of the present invention are described in, and will be apparent from, the following Detailed Description of the Invention and the Figures.

### BRIEF DESCRIPTION OF THE FIGURES

FIG. 1 shows a block diagram of a device for carrying out the method according to the teachings of the present invention.

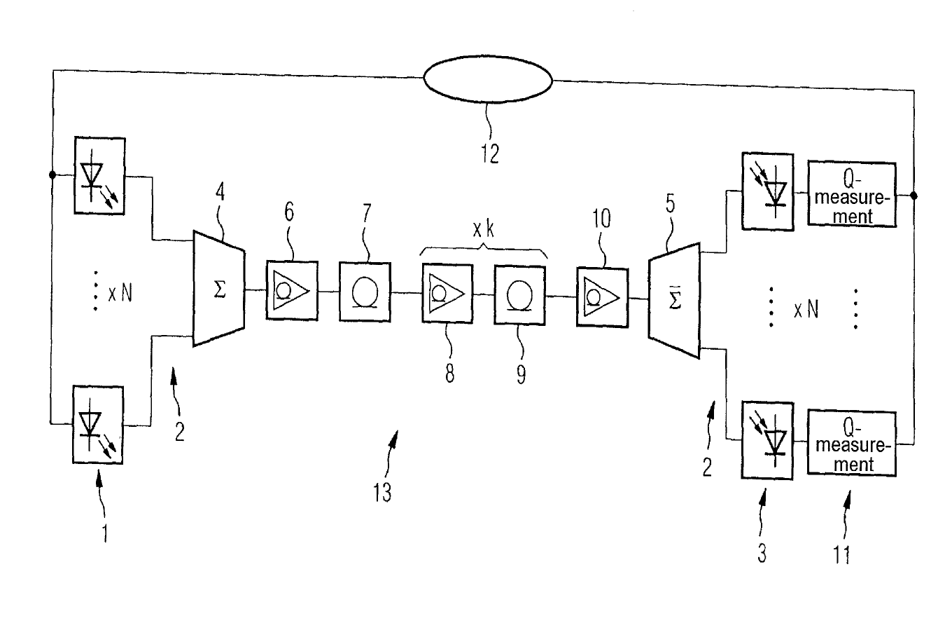

### DETAILED DESCRIPTION OF THE INVENTON

A WDM system 13 is shown which has N transmitters 1 in the form of lasers of different wavelengths. The individual channels 2 fed by the transmitters 1 are combined in a multiplexer 4 to form a single optical signal. This is formed by a booster 6, a first link section 7 and a further link section which is composed of k intermediate amplifiers 8 and subsequent link sections 9, and a preamplifier 10. The optical signal is split into its individual channels 2 by a demultiplexer 5 and forwarded to N receivers 3.

In a first step, equal signal levels are set as starting values at the beginning of the link for all channels 2. The input levels thus set are optimized at the beginning of the link via an OSNR preemphasis of the channel levels. In this process, the level distribution at the beginning of the link is controlled in such a manner that all channels 2 have the same OSNR at the end of the link. This is followed by a determination of the signal quality of the individual channels 2 at the end of the link.

Each one of the individual receivers 3 is followed by a first decision circuit 11. In the first decision circuits 11, a Q value is determined for each channel 2. This is done by measuring a bit error rate at various decider thresholds and phase angles which deviate from the optimum value. Since high bit error rates occur during this process, it can be done within a short measuring time. Compared with a conventional determination of the bit error rate, i.e. by directly counting errors within a certain period of time, an enormous time saving is obtained, especially at low error rates. Following this, the bit error rate is determined at the optimum operating point by extrapolating the measured values for each individual channel 2. From this, the associated Q value is determined for each channel 2.

The levels of the individual channels 2 at the beginning of the link are raised or lowered, respectively, with a constant aggregate level via a control device 12 which receives all Q values. At a low Q value, the level of the associated channel 2 is raised. In contrast, the level of the associated channel 2 at the beginning of the link is lowered with a high Q value. Raising the level at the beginning of the link usually raises the OSNR value of the channel 2 at the end of the link.

However, the Q value takes into consideration not only the OSNR of the respective channel 2 but also the signal distortion, and thus allows a much better estimate of the bit error rate to be obtained. During the measurement of the Q value by displacing the decider threshold of the receiver 3, it is not only distortion in the transmitter 1 and along the link which is detected but also distortion in the receiver 3. After a successful control operation via the first decision circuits 11 and the control device 12, the bit error rates are equal at the end of the link. This results in excellent utilization of the system resources for WDM system 13, and thus in a maximum path length which can be bridged.

Although the present invention has been described with reference to specific embodiments, those of skill in the art will recognize that changes may be made thereto without departing from the spirit and scope of the invention as set forth in the hereafter appended claims.

1. A method for equalizing channel quality differences in a WDM system having N transmitters, N receivers and N channels, the method comprising the steps of:
measuring separately a bit error rate of each of the N channels in each of the N receivers, the bit error rates being respectively measured at different decider thresholds and phase angles, deviating from an optimum value, in N first decision circuits;
determining a bit error rate at an optimum operating point by extrapolating the measured bit error rates for each of the N channels;
determining a Q value for each of the N channels from the respectively associated extrapolated bit error rates;
calibrating the N transmitters via a control device by raising levels of the channels having a small Q value and lowering levels of the channels having a large Q value at a ratio of the respective Q value of the channel, an aggregate level of all N channels in the N transmitters being kept constant; and
repeating all of the above steps until all N Q values of the N channels in the N receivers are equal.

2. A method for equalizing channel quality differences in a WDM system as claimed in claim 1, the method further comprising the step of:
carrying out preemphasis, prior to the step of measuring, in which a level distribution in the N transmitters is changed such that OSNR values of the N channels are matched in the N receivers by measuring OSNR values in the N receivers and controlling the level distribution in the N transmitters via the control device.

3. A method for equalizing channel quality differences in a WDM system as claimed in claim 1, wherein level adjustment of the WDM system to equal Q values is carried out via external measuring equipment during installation.

4. A method for equalizing channel quality differences in a WDM system as claimed in claim 1, the method further comprising the step of:
measuring the NQ values of the N channels in a second decision circuit, associated with the respective receiver, during operation of the WDM system.
